(19) United States
(12) Patent Application Publication
(10) Pub. No.: US 2018/0338651 A1
(43) Pub. Date: Nov. 29, 2018

(54) TOILETRY SUPPORT SYSTEM FOR SHOWER WALLS

(71) Applicant: William F. Burtt, Lowell, MI (US)

(72) Inventor: William F. Burtt, Lowell, MI (US)

(21) Appl. No.: 15/987,655

(22) Filed: May 23, 2018

Related U.S. Application Data
(60) Provisional application No. 62/510,052, filed on May 23, 2017.
(60) Provisional application No. 62/572,746, filed on Oct. 16, 2017.

(51) Int. Cl. A47K 17/00; F16B 47/00; F16M 13/02; F16B 1/00; F16B 45/00; F16B 11/00

(52) U.S. Cl. CPC A47K 17/00; F16B 47/00; F16M 13/022; F16B 2001/0035; F16B 45/00; F16B 11/006; F16B 1/00

(57) ABSTRACT

A toiletry support system for a shower wall includes a wall plate that has an outer planar surface and an inner planar surface opposite the outer planar surface. A wall attachment structure is disposed at the inner planar surface of the wall plate and is configured to attach at and support the wall plate at the shower wall. A toiletry support structure is disposed at the outer planar surface at the wall plate. An engagement device is configured to be disposed at a toiletry item and removably engage the toiletry support structure to suspend the toiletry item at the wall plate.

### CROSS-REFERENCE TO RELATED APPLICATIONS

This application claims benefit and priority under 35 U.S.C. § 119(e) of U.S. provisional application Ser. No. 62/510,052, filed May 23, 2017 and U.S. provisional application Ser. No. 62/572,746, filed Oct. 16, 2017, which are hereby incorporated herein by reference in their entireties.

### TECHNICAL FIELD

The present disclosure generally relates to toiletry support or holding devices, and more particularly to toiletry support devices and systems that can be attached or hung at or near a shower wall or similar bathing area.

### BACKGROUND

It is relatively common for toiletries, such as shampoo and conditioner bottles, along with bars of soap and other related items to be held in a shower caddy, such as a shelf or basket system that attaches around a shower head or other bathroom fixtures. These shower caddies have several horizontal surfaces that can easily accumulate water and soap residue, and can also crowd areas of the shower used for bathing, such as around and near a shower head area of a shower stall. Further, bottles of shampoo and conditioner and other liquid soaps must typically be lifted and removed from these shower caddies for a user to release the contents for use.

### SUMMARY

The present disclosure provides a support device or system that is configured to support a toiletry item at an upright or vertical surface, such as a shower wall or the like in a manner that positions the toiletry item in a convenient and easily accessible location. For example, a plastic bottle that holds shampoo or conditioner or soap or the like may be removably engaged at a shower wall via the toiletry support system, such as in a downwardly-directed orientation that allows the contents of the bottle to be dispensed without disengaging the toiletry item from the shower wall. Such a toiletry support system may be adaptable to support various types and shapes of toiletry items, such as various sized and weighted bottles.

According to one aspect of the present disclosure, a toiletry support system for a shower wall includes a wall plate that is configured to engage a shower wall or other upright surface. A wall attachment structure may be disposed at an inner portion of the wall plate and may attach at and support the wall plate at the shower wall, such as a suction device, adhesive, fasteners, or other permanent or temporary attachment. A toiletry support structure may be disposed at an outer portion at the wall plate, such as a magnetic attachment member or hook member or the like. An engagement device may be disposed at a toiletry item to removably engage the toiletry support structure and thereby suspend the toiletry item at the wall plate in a desired orientation. The engagement device may comprise a receptacle that is attached to or integrally formed at an exterior portion of the toiletry item and configured to detachably engage a hook member. Alternatively, the engagement device may comprise a magnetically attractive member, such as a magnetized ferromagnetic material or a non-magnetized metal, such as iron or the like, where the magnetically attractive member may attached at an exterior portion of the toiletry item or may have a shape that is sized to be entirely inserted into a plastic container or bottle that holds shampoo, conditioner, or liquid soap or the like.

According to another aspect of the present disclosure, a toiletry support system for a shower wall includes a wall plate that has an inner surface that is configured to engage a shower wall and support the wall plate at the shower wall. A hook member may have a base portion that is attached at the wall plate and an arm portion that extends away from the base portion. The arm portion may engage a receptacle that is disposed at a toiletry item to hang the toiletry item at the wall plate. Optionally, the arm portion of the hook member may include a substantially planar shape that is disposed in parallel alignment with an outer surface of the wall plate, such that the arm portion may be configured to engage a slotted aperture of the receptacle disposed at the toiletry item.

According to yet another aspect of the present disclosure, a toiletry support system for a shower wall includes a wall plate that has an outer planar surface and an inner planar surface opposite the outer planar surface configured to engage a shower wall. A wall attachment structure is disposed at the inner planar surface of the wall plate and is configured to attach at and support the wall plate at the shower wall. A toiletry support structure is disposed at the outer planar surface at the wall plate. An engagement device may be configured to be disposed at a toiletry item and removably engage the toiletry support structure to suspend the toiletry item at the wall plate.

These and other objects, advantages, purposes, and features of the present invention will become apparent upon review of the following specification in conjunction with the drawings.

### BRIEF DESCRIPTION OF THE DRAWINGS

FIG. 1 is an upper perspective view of a support device having a toiletry item magnetically attached at a wall plate, in accordance with the present disclosure;

FIG. 2 is an upper perspective view of the wall plate shown in FIG. 1, illustrated without the magnetically attached toiletry item;

FIG. 3 is a front elevation view of the wall plate shown in FIG. 2;

FIG. 4 is a rear elevation view of the wall plate shown in FIG. 2;

FIG. 5 is a cross-sectional view of the wall plate taken at line V-V shown in FIG. 1;

FIG. 5A is a cross-sectional view of an additional embodiment of a support device having a toiletry item magnetically attached at the wall plate shown in FIG. 2;

FIG. 6 is a perspective view of an additional embodiment of a support device having two toiletry items magnetically attached at a wall plate;

FIG. 7 is an elevational view of the wall plate of the support device shown in FIG. 6, illustrated without the magnetically attached toiletry items;

FIG. 8 is a perspective view of two embodiments of support devices, each having two toiletry items magnetically attached each of the illustrated wall plates;

FIG. 9 is an elevational view of a shampoo bottle shown in FIG. 8, showing a magnetic attachment member disposed at the bottle;

FIG. 10 is an elevational view of a bar of soap shown in FIG. 8, showing another embodiment of a magnetic attachment member disposed at the bar of soap;

FIG. 11A is an elevational view of another embodiment of a second magnetic attachment feature having a metal plate disposed in a plastic sheathing;

FIG. 11B is an elevational view the plastic sheathing shown in FIG. 11A, illustrated without the metal plate disposed in the plastic sheathing;

FIG. 12 is an upper perspective view of an additional embodiment a support device, showing a toiletry item engaged at the wall plate and another disengaged from the wall plate;

FIG. 13 is a cross-sectional view of the support device and engaged interface of the toiletry item, taken at line XIII-XIII shown in FIG. 12;

FIG. 14 is an upper perspective view of an additional embodiment a support device, showing a toiletry item engaged at the wall plate and another disengaged from the wall plate;

FIG. 15 is a lower perspective view of the support device disengaged from and the toiletry shown in FIG. 14;

FIG. 16 is a cross-sectional view of the support device and engaged interface of the toiletry item, taken at line XVI-XVI shown in FIG. 14;

FIG. 17 is an upper perspective view of an additional embodiment a support device, showing a toiletry item engaged at the wall plate and another disengaged from the wall plate;

FIG. 18 is a lower perspective view of the support device disengaged from and the toiletry shown in FIG. 17;

FIG. 19 is a cross-sectional view of the support device and engaged interface of the toiletry item, taken at line XIX-XIX shown in FIG. 17;

FIG. 20 is an upper perspective view of an additional embodiment of a toiletry item having a pocket integrally formed at a wall of a bottle;

FIG. 21 is a cross-sectional view of the toiletry item and pocket, taken at line XXI-XXI shown in FIG. 20;

FIG. 22 is a cross-sectional view of the toiletry item and pocket, taken at line XXII-XXII shown in FIG. 20;

FIG. 23 is an upper perspective view of an additional embodiment of a toiletry item having a slotted pocket integrally formed at a wall of a bottle;

FIG. 24 is a cross-sectional view of the toiletry item and the slotted pocket, taken at line XXIV-XXIV shown in FIGS. 23; and

FIG. 25 is a cross-sectional view of the toiletry item and the slotted pocket, taken at line XXV-XXV shown in FIG. 23.

### DETAILED DESCRIPTION

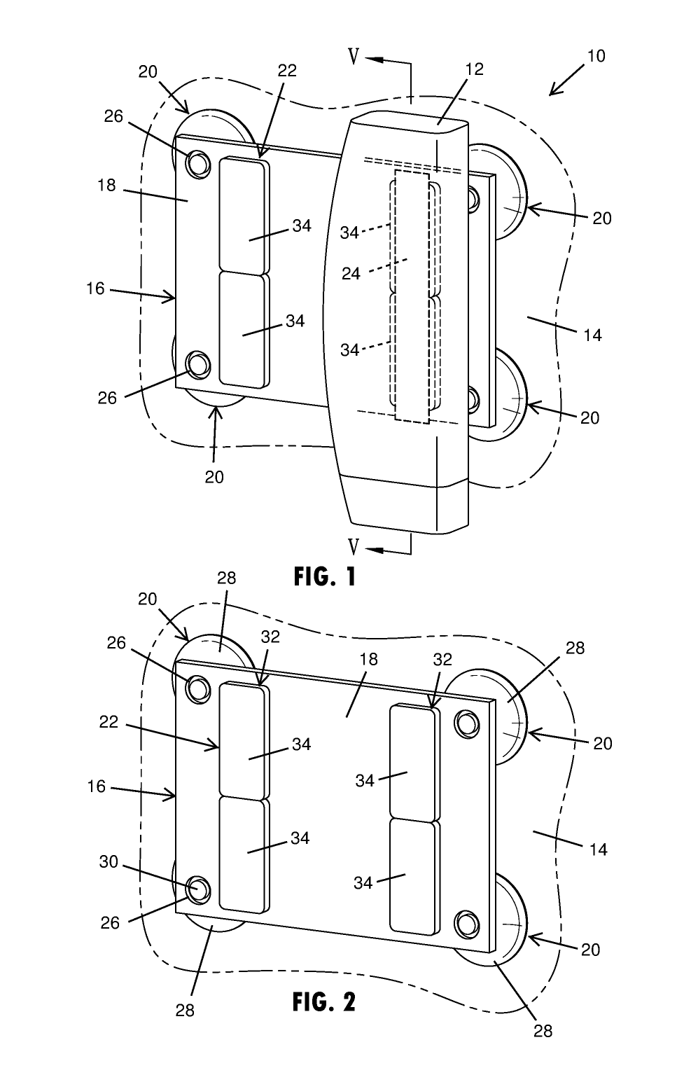

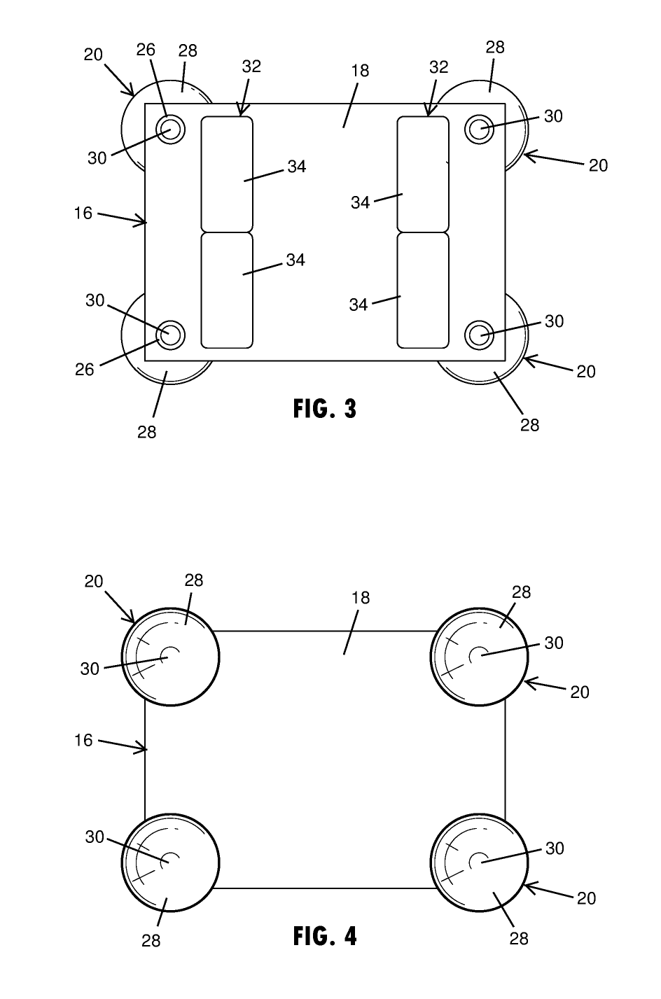

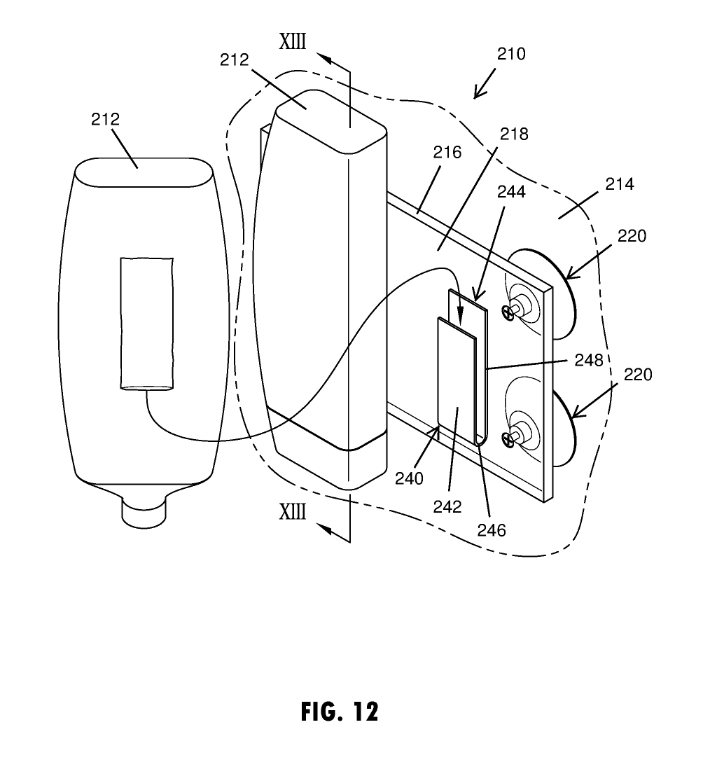

Referring now to the drawings and the illustrative embodiments depicted therein, a toiletry support system 10, 110, 210, 310, 410 is provided to removably attach and secure a toiletry item 12, 112a-112d, 212, 312, 412, 512, 612 at an upright or vertical surface, such as a shower wall or the like, in a manner that supports the toiletry item in a convenient and easily accessible location near or within a shower stall or other bathing area. The toiletry support system 10, 110 may provide mechanical or magnetic attachment of the toiletry item 12, 112a-112d. As shown in FIGS. 1-10, the toiletry item 12, 112a-112d can be easily disengaged from the magnetic coupling, such as for use or replacement, and then reengaged via the magnetic coupling to hold the toiletry item 12, 112a-112d near or within the shower or bathing area. Alternatively, the toiletry support system 210, 310, 410 may include a thin support feature, such as a hook member, such as shown in FIGS. 12-25, that provides an arm portion configured, such as with a thin or planar shape, to engage a receptacle disposed at a toiletry item to hang the toiletry item at the wall plate in a supportive and non-intrusive manner. When the toiletry item is disengaged for use or replacement, the support system may thus be relatively unnoticeable and may be free of shelves or other substantial protruding portions that may otherwise interfere with the usable space within a shower or bathing area. Further, when the toiletry item is attached or engaged at the support system, such as for convenient storage and holding within the shower or bathing area, the toiletry item may primarily be the only visible and noticeable item, so as to provide a clean and organized environment within the shower or bathing area.

The toiletry support system may provide one component that is fixed to the upright or vertical surface of the shower or bathing area and another component that is secured to the toiletry item, such that the two components may be removably attached and/or magnetically attracted to each other so as to engage with sufficient force to freely support the weight of the toiletry item at the upright or vertical surface. As shown in FIGS. 1-5A, the fixed component of the toiletry support system 10 may include a wall plate 16 that provides an outer surface 18 for interfacing with the toiletry item 12. The fixed component, depicted as the wall plate 16, also includes a wall attachment structure or feature 20 on the opposing inner side from the outer surface 18 that is configured to engage and support the wall plate 16 at a vertical or upright surface 14, such as a shower wall. A fixed magnetic attachment member 22 may be disposed at or near the outer surface 18 of the wall plate 16 and arranged to magnetically couple with a separate and distinct second magnetic attachment member 24 (FIG. 1). The magnetic attachment member 22 may be an integral part of the fix component, such as the wall panel 16 itself, or may be separately coupled with the fixed component, such as attached adhered to the wall panel 16 with a fastener or adhesive or the like.

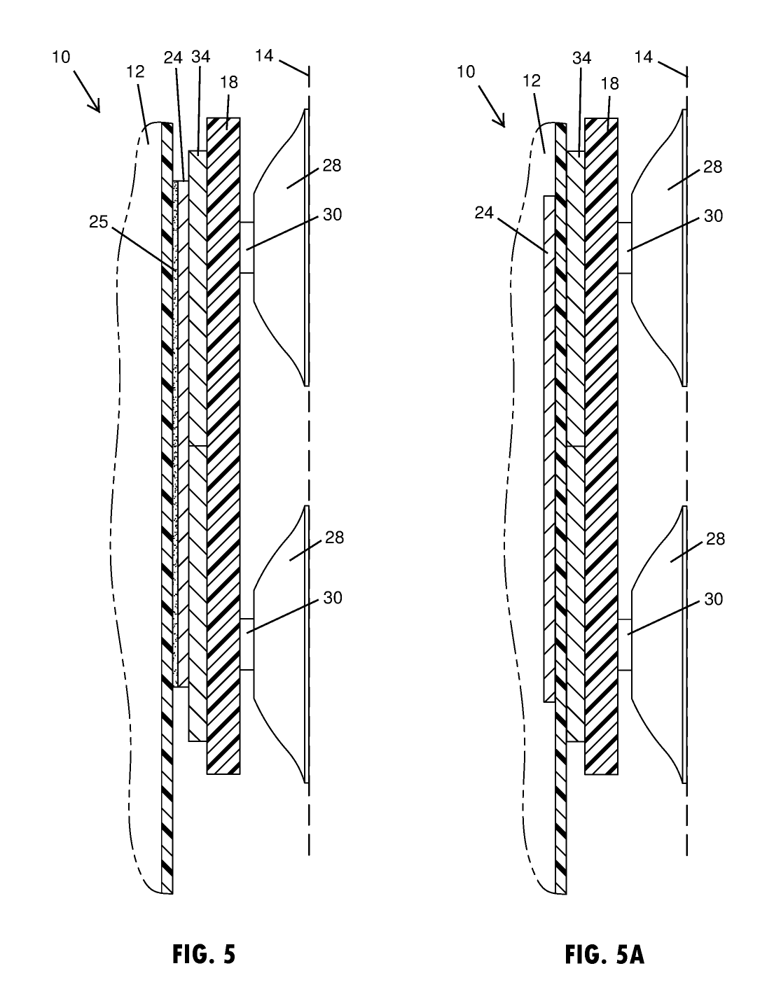

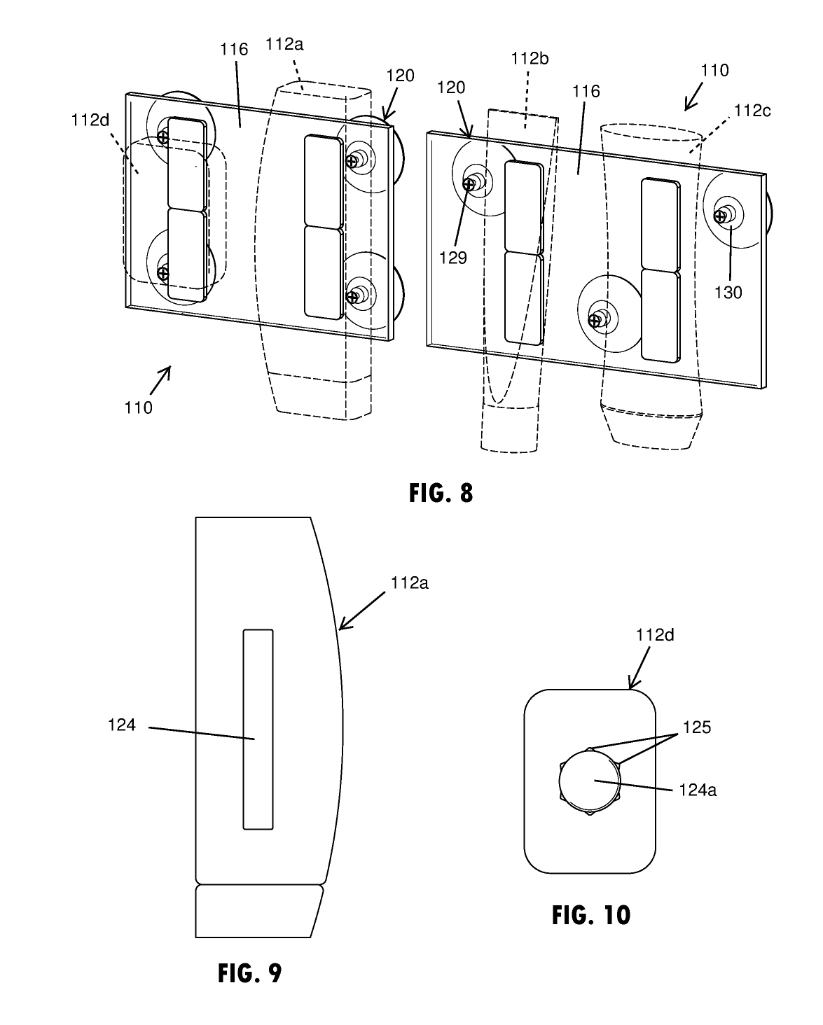

The toiletry support system 10 may also include another magnetic attachment member, such as a magnetically attractive member 24, which may be integrated or engaged or attached to the toiletry item 12, such as by attaching the magnetically attractive member 24 at an exterior surface of the toiletry item 12 with an adhesive 25 as shown in FIG. 5, or by submerging or inserting at least a portion of the magnetically attractive member 24 into or within the toiletry item 12 as shown in FIG. 5A. For example, as shown in FIG. 1, the magnetically attractive member 24 is attached to the exterior surface of the shampoo bottle 12 and is in magnetic engagement with the magnetic attachment member 22 so as to conceal the magnetic attachment member when the bottle 12 is attached therewith. Alternatively, as shown in FIG. 5A, the sidewall of the shampoo bottle 12 is pinched between the first and second magnetic attachment members 22, 24. Thus, when the magnetically attractive member 24 is magnetically coupled with the magnetic attachment member 22, the toiletry item 12 is releasably engaged and entirely supported at the wall plate 16. The toiletry item 12 depicted in FIG. 1 is a plastic bottle, such as for holding shampoo or conditioner or other liquid soap. The toiletry item may also be embodied as various other items, such as the three different plastic bottles 112a, 112b, 112c and also as the bar of soap 112d shown in FIG. 8. Further, it is also conceivable that the toiletry item may be embodied as another type of shower item, such as a razor or washing sponge or a related item.

As shown in FIGS. 1-5, the toiletry support system 10 provides a wall plate 16 that is rectangular in shape and formed with a nylon material to have a substantially white and opaque appearance. It is contemplated that in other embodiments of the toiletry support system, the fixed component may be a differently shaped component than the illustrated plate. The outer surface 18 is substantially planar and includes four recessed apertures 26 at the corners of the wall plate 16 for securing the wall attachment structures 20. Specifically, the wall attachment structures 20 shown in FIGS. 1-5 are suction cups that have a cup portion 28 disposed on the opposing side from the outer surface 18. The suction cups 26 also include an engagement portion 30 that has a neck section extending from the cup portion 28 to a bulbous head section. The head section of the engagement portion 30 is compressed and urged through the recessed apertures 26 at the corners of the wall plate 16, such that the neck section is disposed through the aperture 26, while the head section and cup portion 28 are held at opposing sides of the wall plate 16 to retain the suction cups 20 in the apertures 26. The wall attachment structure 20 is configured to engage and support the wall plate 16 at a vertical or upright surface, such as by the suction cups 20 providing sufficient suction and adhesion at a shower wall to support the engaged toiletry item 12 or items at the wall plate 16. It is contemplated that the wall attachment structure may also or alternatively comprise an adhesive or other attachment meaning that preferably does not pierce or otherwise damage the vertical or upright surface of the shower or bathing area.

As further shown in FIGS. 2-5, the magnetic attachment member 22 is provided as two magnetic columns 32, where each column is shown having two permanent magnets 34 attached to the outer portion or surface 18 of the wall plate 16 and arranged spaced from each other sufficient to allow magnetically coupling with the separate magnetically attractive members 24, so as to be able to attach at least two toiletry items 12 at the wall plate 16. The wall plate in additional embodiments may include recesses or openings for the magnetically attractive members, such as permanent magnets, to be frictionally secured by the structure of a wall plate in addition to or in the alternative to adhesive or fastener that secure the magnetically attractive members to the wall plate.

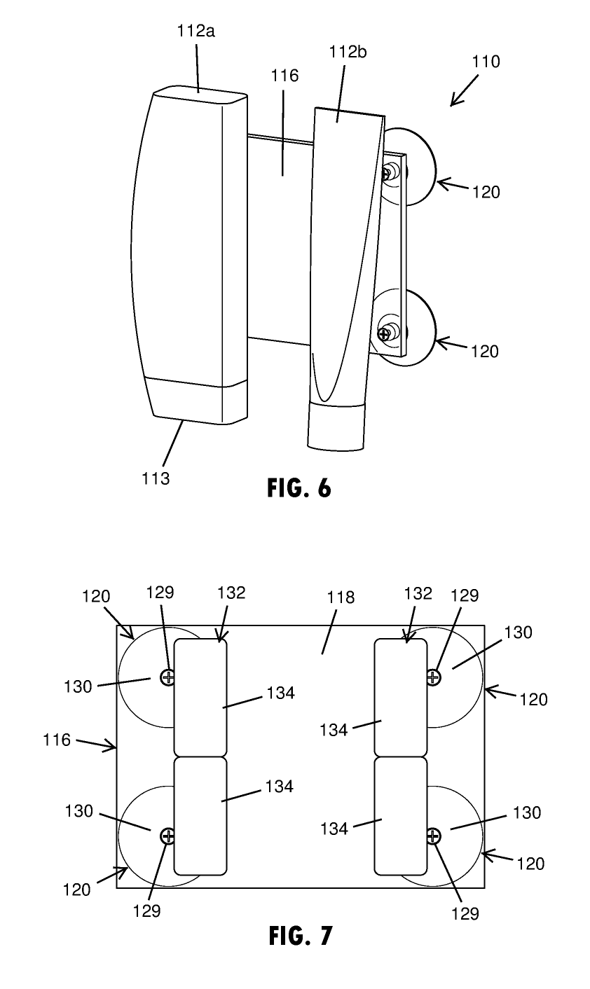

As shown in FIGS. 6-8, a magnetic support system 110 is shown that provides a wall plate 116 that is rectangular in shape and is formed with a translucent material, such as fiber glass or acrylic or other relatively clear materials, to have a substantially clear and translucent appearance. The translucent appearance of the wall plate 116 and suction cups 120, make the magnetic support system 110 substantially unnoticeable as it generally takes on the color and/or patterns of the upright or vertical surface of the shower or bathing area that is engaged by the magnetic support system 110. The outer surface 118 of the wall plate 116 show in FIGS. 6-8 is substantially planar and includes apertures 126 through the wall plate 116 for securing the wall attachment structures 120. One of the wall plates 116 shown in FIG. 8 has these apertures 126 arranged at the four corners, such as also shown in FIG. 7, and the other wall plate 116 has three staggered locations across wall plate 116 with two apertures 126 at the upper corners and one lower aperture 126 generally centered laterally on the wall plate 116.

The wall attachment structures 120 shown in FIGS. 6-8 comprise suction cups that may be entirely disposed between the inner surface of the wall plate 116 and the engaged upright or vertical surface. The suction cups 120 also include an engagement portion 130 that is centrally located on the suction cup 120 and configured to be threadably engaged by a fastener, such as a threaded shank portion of a screw 129 that extends through the wall plate 116. The head portion of the engaged screw 129 may be disposed at or near the outer surface 118 of the wall plate 116. Similar to the other embodiment, the wall attachment structures 120 are configured to engage and support the wall plate 116 at a vertical or upright surface, such as by the suction cups 120 providing sufficient adhesion at a shower wall to support the engaged toiletry item or items at the wall plate 116. By providing at least one suction cup at the upper portion of the wall plate 116 and at least one suction cup at the lower portion of the wall plate 116, the wall plate may be supported at the upright or vertical surface in a manner that prevents the wall plate 116 from tilting or pivoting inward toward the engaged upright or vertical surface, such as may occur when a heavy toiletry item or items are attached at the front surface of the wall plate 116. Thus, at least one suction cup or similar spacing element at the upper and lower portions of the wall plate may maintain the orientation of the wall plate 116 in generally parallel planar alignment with the upright or vertical wall surface at a generally consistent spacing, which may allow for a cap 113 (FIG. 6) of the plastic bottle 112a to be opened for dispensing the contents of the bottle.

As further shown in FIGS. 6-8, the magnetic attachment member 122 may be provided as two magnetic columns 132, with each column shown having two permanent magnets 134 attached to the outer surface 118 of the wall plate 116 and arranged spaced from each other at a sufficient distance to allow for magnetically coupling with separate magnetically attractive members 124, so as to be able to magnetically attach at least two toiletry items 112a, 112b at the wall plate 116. The wall plate 116 shown in FIGS. 6-8 has smooth exterior surface that is adhered to the permanent magnets 134 with a suitable adhesive, such as a tape-based adhesive.

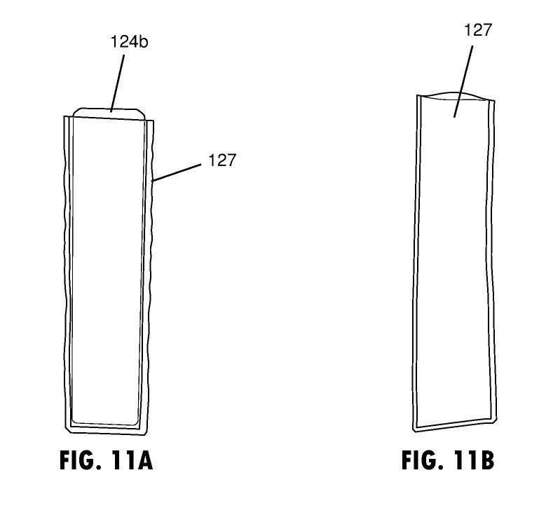

The magnetically attractive member 124 may be integrated or engaged or attached to the respective toiletry item, such as by submerging or imbedding at least a portion of the magnetically attractive member 124 into the toiletry item. The magnetic attachment members and magnetically attractive members may comprise a magnetized ferromagnetic material. Alternatively, the magnetic attachment member or magnetically attractive member may comprise a non-magnetized metal, such as iron or the like, that is capable of magnetically coupling with a permanent magnet. As shown in FIG. 9, the magnetically attractive member 124 is depicted outside of the shampoo bottle 112a in a location where the magnetically attractive member 124 may be positioned when either attached at an exterior surface of the bottle or submerged inside of the bottle. As shown in FIG. 10, the magnetically attractive member 124a includes impaling features 125 that are configured to physically engage into the bar of soap 112d. The impaling feature 125 is shown as the sharp corners of a metal bottle cap, but may also or alternatively be shanks or other similar features to engage by being embedded in a bar of soap 112d. Further, as shown in FIG. 11A, the magnetically attractive member 124b is an elongated piece of metal that has a width that is sized to be entirely inserted into a plastic container or bottle that holds shampoo, conditioner, or liquid soap or the like. The magnetically attractive member 124b may be disposed in a protective covering, such as a polymer sheathing 127 as shown in FIG. 11B. Such a polymer sheathing 127 may provide a sealed exterior surface to prevent a liquid from contacting the non-magnetized metal. Such a sheathing 127 may be a loose bag that is sealed around the metal piece or may be a coating or layering of protective material applied to the exterior surface of the metal piece to provide similar protective measures. It is also contemplated that such a protective covering may be omitted, such as when using a magnetically attractive member formed of stainless steel.

With respect to the use of a toiletry support system to magnetically support a toiletry item at a shower wall, the wall plate may engage or attach at a shower wall or other upright surface via a suction device, adhesive, fastener, or the like. When attached at the vertical or upright surface, the wall plate has an outer planar surface that includes a first magnetic attachment member. A second magnetic attachment member is provided at a toiletry item, such as a container or bottle of shampoo, conditioner, and/or liquid soap or the like. To do so, it is possible that cap of the bottle may be removed for the second magnetic attachment member to be submerged into the contents of the bottle, and then the cap may be reattached. When the toiletry item is moved into close proximity, at or near the outer surface of the wall plate, the first magnetic attachment member is magnetically coupled with the second magnetic attachment member with sufficient force to suspend the toiletry item at the outer planar surface of the wall plate, without the assistance of any other supportive structure.

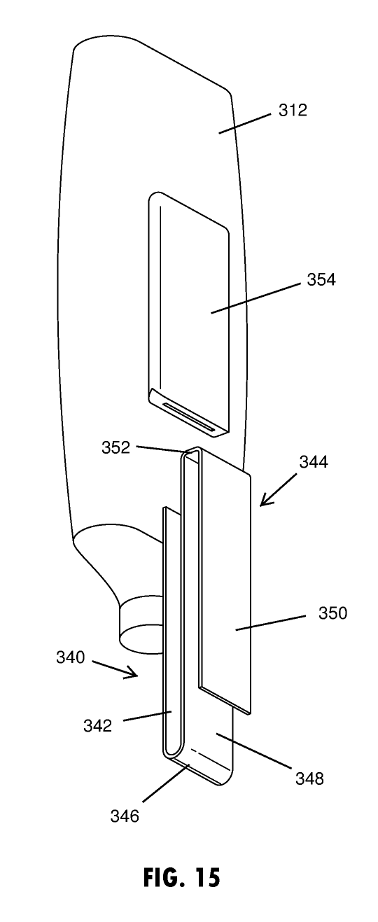

Referring now to FIGS. 12-25, additional embodiments of the toiletry support system 210, 310, 410 provide for mechanical attachment of a toiletry item, such as with a hook member 240, 340, 430 that provides an arm portion 242, 342, 442 that is thin and planar shaped, so as to be able to engage a receptacle disposed at a toiletry item to hang the toiletry item at the wall plate and still remain relatively obstructing in a shower or bathing area. A wall plate 216 may be used that has an inner surface configured to engage and support the wall plate 216 at the shower wall, such as with the wall attachment structures described in the embodiments above. The outer surface 218 of the wall plate 216, as show in FIG. 15, is also substantially planar. The illustrated wall plate 216 has a rectangular shape and is formed with a transparent material, such as a polymer or fiber glass material to have a substantially clear and translucent appearance. The translucent appearance of the wall plate permit the shower wall to be visible through the wall plate 216, thus assisting with making the magnetic support system 210 substantially unnoticeable as it generally takes on the color and/or patterns of the upright or vertical surface of the shower or bathing area that is engaged by the support system 210. It is also conceivable that the wall plate may be a metal or ceramic or otherwise opaque material, such as an aluminum plate.

The hook member 240, as shown in FIGS. 12-15, may have a base portion 244 attached at the wall plate 216 and an arm portion 242 extending away from the base portion 244. The arm portion 242 may be configured, such as with a thin or planar shape, to engage a receptacle disposed at a toiletry item to hang the toiletry item at the wall plate, such as shown in FIG. 15. The arm portion 242 of the hook member 240 is show having a substantially consistent thickness, such as provided by a strip of sheet metal, which may be configured to engage a thin slotted aperture of a receptacle disposed at the toiletry item 212. The illustrated metal strip used to form the hook member 240 has dimensions of approximately 3/4 inch by approximately ⅛ inch. The substantially planar shape of the illustrated arm portion 242 of the hook member 240 is disposed in approximately parallel alignment with an outer surface 218 of the wall plate 216. As such, the hook member 240 has a U-shaped portion 246 that interconnects the base portion 244 and the arm portion 242, where the U-shaped portion 246 may be provided as a bend point along a strip of sheet metal that is used to make the hook member 240.

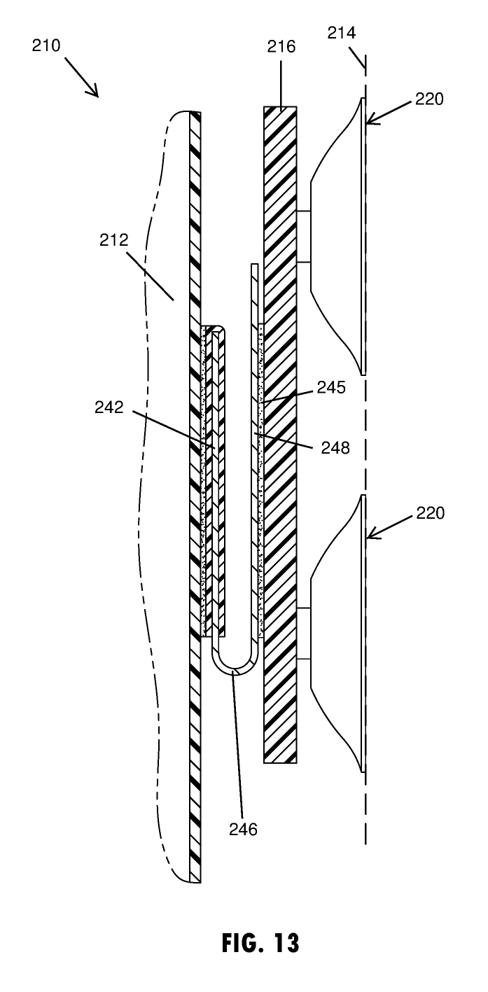

The base portion 244 of the hook member 240 is secured to the wall plate 216 so as to support the arm portion 242 of the hook member 240 and the toiletry item supported at the hook member 240. As shown in FIGS. 12 and 13, may provide a hook member 240 that is adhesively attached at a wall plate 216. The hook member 240 shown in FIGS. 12 and 13 has a base portion 244 having a single planar portion 248 attached at the wall plate 316 and an arm portion 242 extending away from the base portion 244. The base portion 244 of the hook member 240 is secured to the wall plate 216 so as to support the arm portion 242 of the hook member 240 and the toiletry item 212 supported at the hook member 240. As shown in FIG. 12, the base portion 244 may have a planar surface that attaches at an outer surface 218 of the wall plate 216, such as via an adhesive 245 (FIG. 13). Also or alternatively the base portion may be insert molded, press fit, fastened, or otherwise integrally formed with the base plate provide a secure connection between the hook member and the base plate.

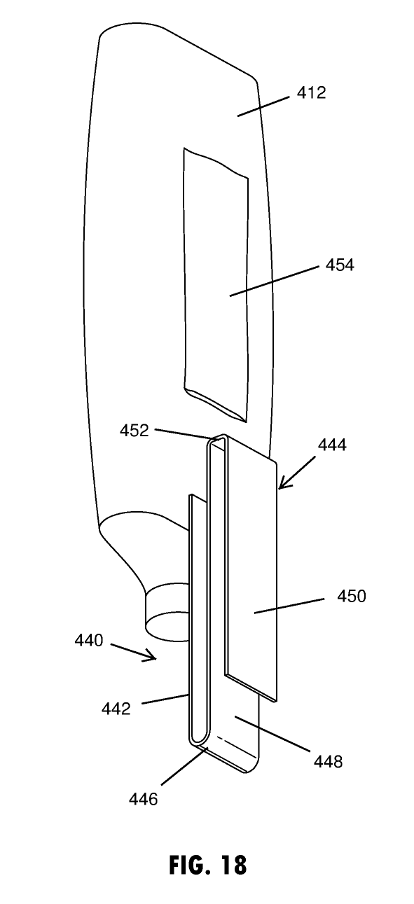

The arm portion 242 may be configured, such as with a thin or planar shape, to engage a receptacle disposed at a toiletry item to hang the toiletry item at the wall plate, such as shown in FIG. 18. The arm portion 342 of the hook member 340 is show having a substantially consistent thickness, such as provided by a strip of sheet metal, that is configured to engage a thin slotted aperture of a receptacle disposed at the toiletry item, such as the illustrated pocket 354. The pocket 354 may be a rigid plastic, such as to generally mimic or appear similar to the rigidity of the plastic bottle 312. The substantially planar shape of the arm portion 342 of the hook member 340 is disposed in parallel alignment with an outer surface 318 of the wall plate 316.

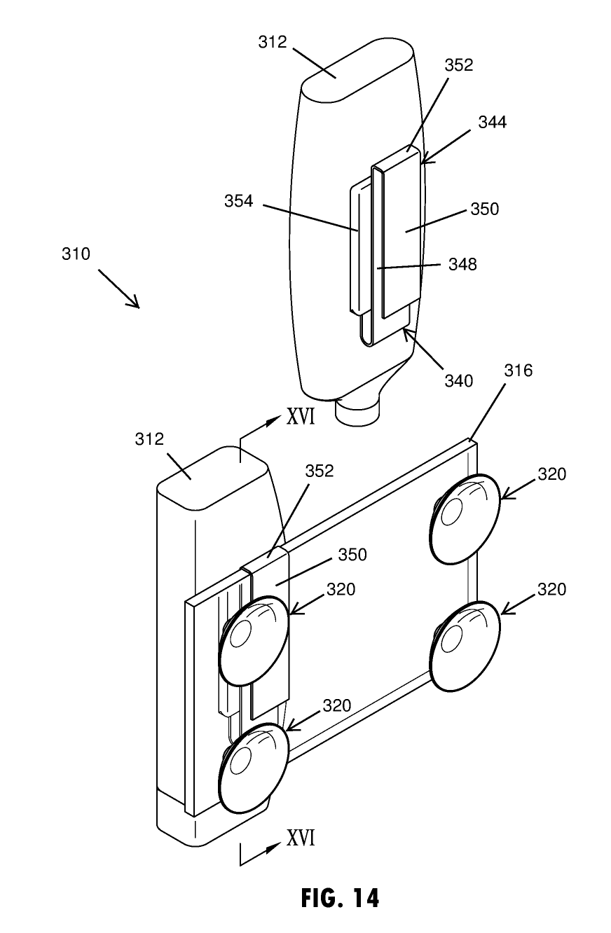

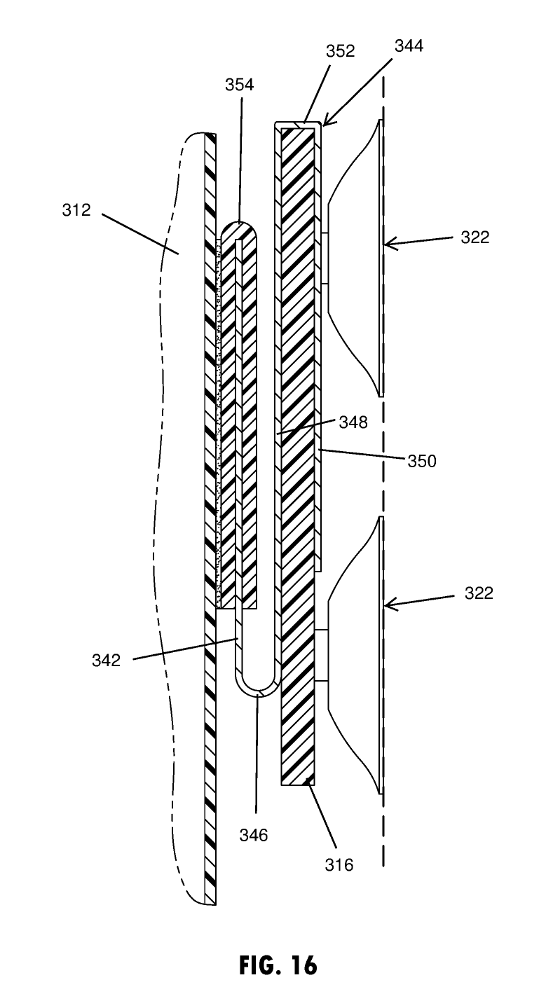

Another embodiment of the toiletry support system 310, as shown in FIGS. 14-16, may have an engagement device that includes a base portion 344 having a hook shaped that is configured to engage over an upper edge of the wall plate 316. Specifically, the base portion 344 as shown in FIG. 16 has two opposing planar sections 348, 350 that are spaced apart a distance substantially equal to the thickness of the wall plate 316, such that the wall plate 316 contacts both planar sections 348, 350 of the hook-shaped base portion 344. The opposing planar sections 348, 350 are interconnected by edge section 352 that is shown having a substantially planar intermediate area for engaging the edge surface of the wall plate 316, which as shown in FIG. 15, may be substantially perpendicular to the inner and outer surfaces of the wall plate 316. Thus, as shown in FIG. 16, the base portion 344 and the arm portion 342 of the hook member 340 may together comprises an generally S shape that provides opposing hooks to respectively engage over the upper edge of the wall plate and engage the toiletry item.

The wall plate 316 may have an inner surface configured to engage and support the wall plate 316 at the shower wall, such as with the wall attachment structures described in the embodiments above. The outer surface 318 of the wall plate 316, as show in FIG. 16, is also substantially planar. The illustrated wall plate 316 has a rectangular shape and is formed with a transparent material, such as a polymer or fiber glass material to have a substantially clear and translucent appearance. Like the wall plates described above, the wall plate of this embodiment may be provided with alternative sizes, shapes and thicknesses to accommodate the desired arrangement of the respective toiletry support system.

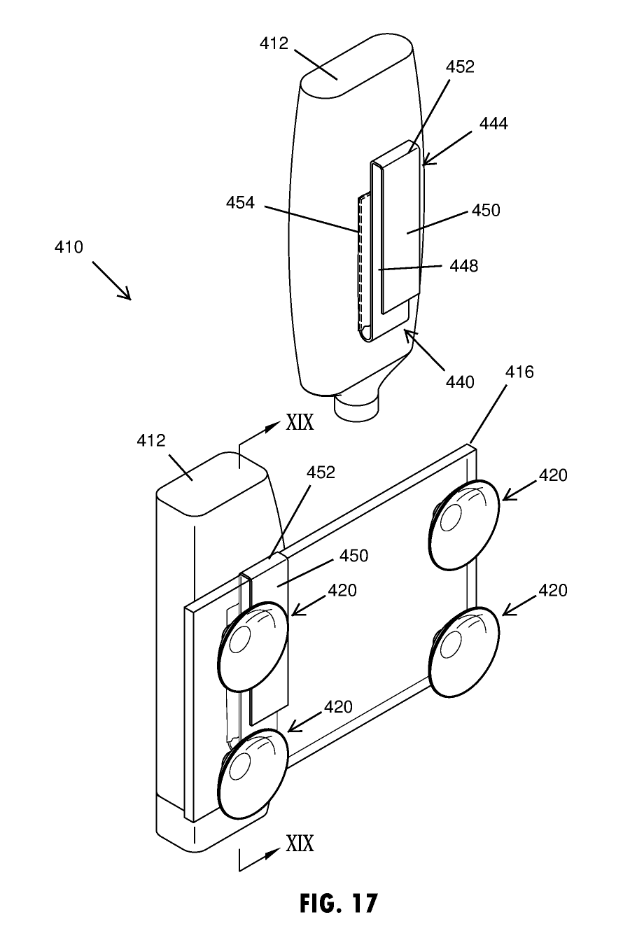

The additional embodiment of the hook member 440, as shown in FIGS. 17-19, may have a base portion 444 configured to attach at a wall plate or the like and an arm portion 442 extending away from the base portion 444. The arm portion 442 may be configured, such as with a thin or planar shape, to engage a receptacle disposed at a toiletry item to hang the toiletry item at a wall of a shower or bathing area. The arm portion 442 of the hook member 440 is show having a substantially consistent thickness, such as provided by a strip of sheet metal that is configured to engage a thin slotted aperture of a receptacle disposed at the toiletry item. The hook member 440 has a U-shaped portion 446 that interconnects the base portion 444 and the arm portion 442, where the U-shaped portion 446 may be provided as a bend point along a strip of sheet metal that is used to make the hook member 440. Like the hook member 340, the hook member 440 has a base portion 444 having a hook shaped that is configured to engage over an upper edge of the wall plate 416

The toiletry item 412 as illustrated in FIGS. 17-19 may be supported by a polymer slip pocket 454 that may be attached at the toiletry item via an adhesive backing or two sided tape or the like, such that the arm portion 442 of the hook member 440 may be inserted within the sleeve 454 to hold the toiletry item at the shower wall. In the illustrated arrangement, the pocket 454 is attached at the toiletry item 412, depicted in FIG. 18 as a plastic bottle such as for holding shampoo or conditioner or other liquid soap, with the opening of the pocket 454 directed toward the cover or cap of the conditioner bottle, such the hook member 440 holds the conditioner bottle in a downward direction that allows dispensing of the contents without removing the plastic bottle from the hook member 440.

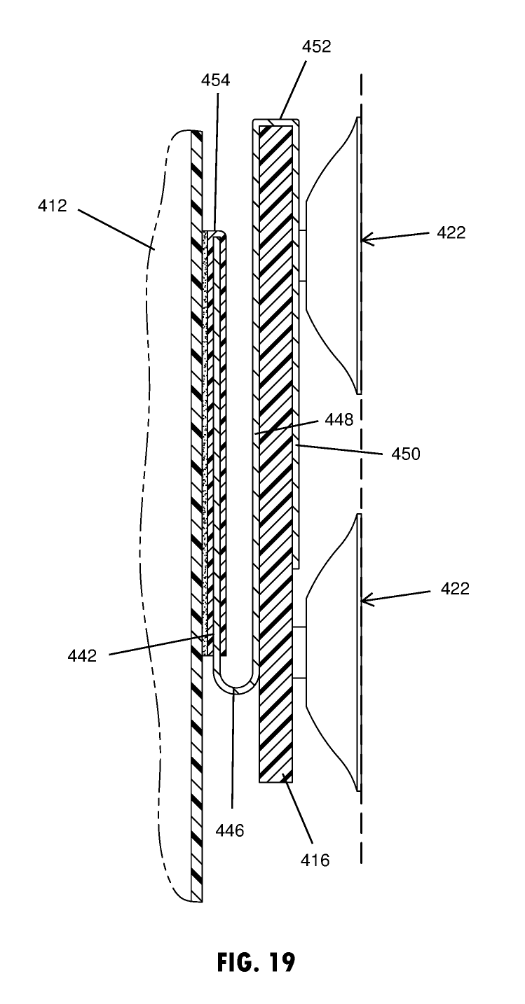

As further shown in FIGS. 17-19, the base portion 444 has a hook shaped that is configured to engage over an upper edge of a wall plate. Specifically, the base portion 444 as shown in FIG. 19 has two opposing planar sections 448, 450 that are spaced apart a distance substantially equal to the thickness of the wall plate or other feature configured to mount at a wall surface, such that both planar sections 448, 450 of the hook-shaped base portion 444 engage opposing sides of the wall plate or other feature. The opposing planar sections 448, 450 are interconnected by edge section 452 that is shown having a substantially planar intermediate area for engaging the edge surface of a wall plate, which as shown in FIG. 19, may be substantially perpendicular to the inner and outer surfaces of the wall plate 416. Thus, the base portion 444 and the arm portion 442 of the hook member 440 may together comprises an generally S shape that provides opposing hooks to respectively engage over the upper edge of the wall plate and engage the toiletry item.

The toiletry item 412 illustrated in FIG. 18 is supported by a polymer sheathing or sleeve 454 that may be attached at the toiletry item via an adhesive or two sided tape or the like, such that the arm portion of the hook member may be inserted within the sleeve 254 to hold the toiletry item at the shower wall. In this arrangement, the sleeve 454 is attached at the toiletry item 412, depicted in FIG. 17 as a plastic bottle such as for holding shampoo or conditioner or other liquid soap, with the opening of the sleeve 454 directed toward the cover or cap of the conditioner bottle, such the hook member 440 holds the conditioner bottle in a downward direction that allows dispensing of the contents without removing the plastic bottle from the hook member 440. It is also contemplated that the toiletry item may have the receptacle integrated therewith, such as a container or bottle or that is formed with a slot or aperture or loop or the like as an integral feature of the container or bottle.

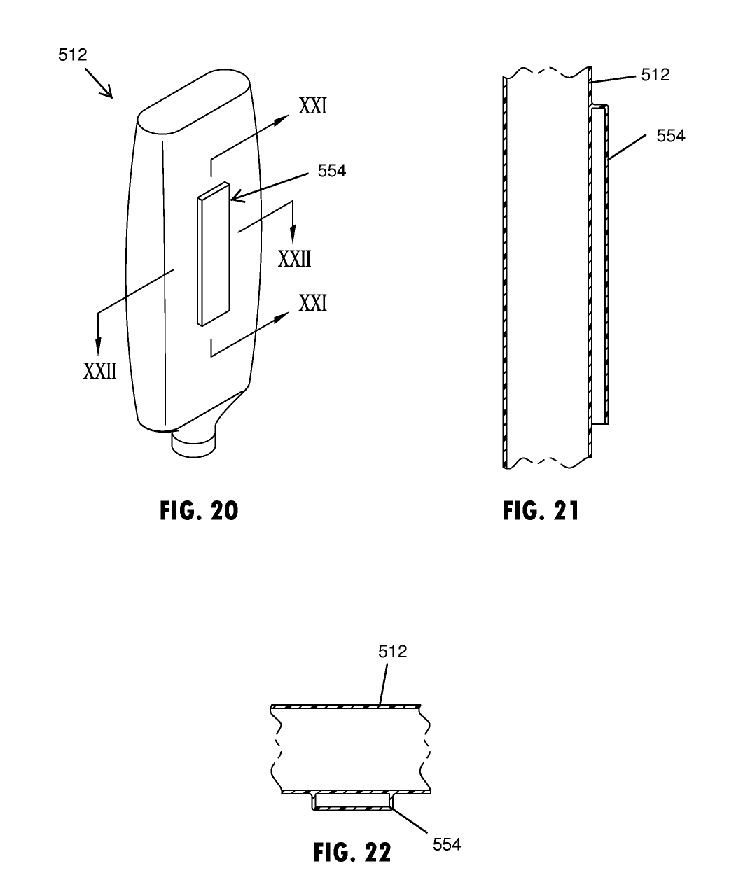

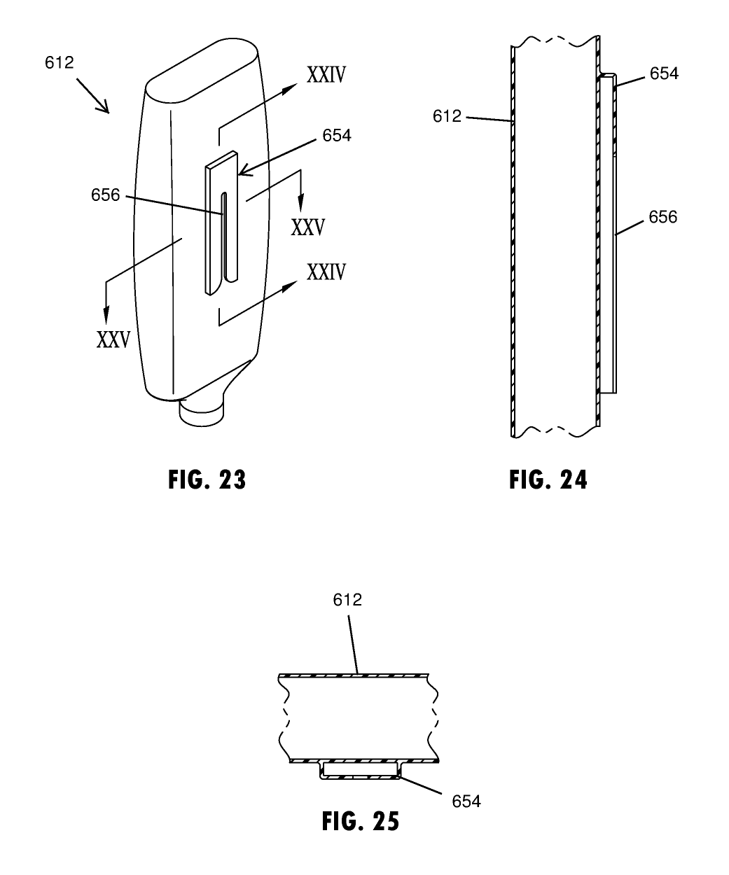

Moreover, as shown in FIGS. 20-25, the toiletry item may have the receptacle integrated therewith, such as a container or bottle 512, 612 that is formed with a pocket 554, 654 that is an integral feature of the container or bottle. As shown in FIGS. 20-22, the pocket 554 includes an outer wall that is spaced from an inner wall that is an integral portion of the container wall that forms container or bottle 512. The outer wall integrally connects with the inner wall at three side or edge portions of the outer wall to generally form the opening of the pocket 554. Also, as shown in FIGS. 23-25, the pocket 654 also includes an outer wall that is spaced from an inner wall that is an integral portion of the container wall that forms container or bottle 612. The outer wall of the pocket 654 shown in FIG. 26 includes a slot 656 that extends longitudinally along the outer wall, so as to allow an alternatively shaped toiletry support system, such as a T-shaped protrusion to engage the slotted pocket 654 in a manner that supports the container or bottle 612.

For purposes of this disclosure, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific systems and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A toiletry support system for a shower wall, said toiletry support system comprising:
a wall plate configured to engage a shower wall;
a wall attachment structure disposed at an inner portion of the wall plate and configured to attach at and support the wall plate at the shower wall;
a toiletry support structure disposed at an outer portion at the wall plate; and
an engagement device configured to be disposed at a toiletry item and removably engage the toiletry support structure to suspend the toiletry item at the wall plate.

2. The toiletry support system of claim 1, wherein the wall attachment structure comprises a suction cup that is configured to engage the shower wall and support the combined weight of the wall plate and the toiletry item supported at the toiletry support structure.

3. The toiletry support system of claim 1, wherein the toiletry support structure comprises a magnetic attachment member fixed at the outer portion of the wall plate and that magnetically couples with the engagement device that is configured to be disposed at the toiletry item.

4. The toiletry support system of claim 3, wherein the engagement device comprises a magnetically attractive member configured to be submerged within or attached at an exterior surface of the toiletry item, and wherein the magnetically attractive member removably engages the magnetic attachment member to support the toiletry item at the wall plate.

5. The toiletry support system of claim 4, wherein the magnetically attractive member comprises a non-magnetized metal.

6. The toiletry support system of claim 3, wherein the magnetic attachment member comprises a magnetized ferromagnetic material.

7. The toiletry support system of claim 1, wherein the wall plate comprises a transparent polymer that is configured to permit the shower wall to be visible through the wall plate.

8. The toiletry support system of claim 1, wherein the wall attachment structure comprises a hook member having a base portion attached at the wall plate and an arm portion extending away from the base portion, and wherein the engagement device comprises a receptacle that is configured to removably engage the arm portion to hang the toiletry item at the wall plate.

9. The toiletry support system of claim 8, wherein the arm portion of the hook member includes a substantially planar shape that is disposed in parallel alignment with an outer surface of the wall plate, and wherein the base portion of the hook member comprises a planar surface that attaches at an outer surface of the wall plate via an adhesive.

10. The toiletry support system of claim 8, wherein the arm portion of the hook member includes a substantially consistent thickness that is configured to engage a slotted aperture of the receptacle disposed at the toiletry item.

11. The toiletry support system of claim 8, wherein the engagement device comprises a sheathing that is configured to attach at the toiletry item via an adhesive, and wherein the sheathing comprises the receptacle that removably engages the arm portion of the hook member.

12. A toiletry support system for a shower wall, said toiletry support system comprising:
a wall plate having an inner surface configured to engage a shower wall and support the wall plate at the shower wall;
a hook member having a base portion attached at the wall plate and an arm portion extending away from the base portion; and
wherein the arm portion is configured to engage a receptacle disposed at a toiletry item to hang the toiletry item at the wall plate.

13. The toiletry support system of claim 12, wherein the arm portion of the hook member includes a substantially planar shape that is disposed in parallel alignment with an outer surface of the wall plate, and wherein the arm portion of the hook member is configured to engage a slotted aperture of the receptacle disposed at the toiletry item.

14. The toiletry support system of claim 12, wherein the base portion of the hook member comprises a planar surface that attaches at an outer surface of the wall plate via an adhesive, and wherein the hook member comprises a U-shaped portion that interconnects the base portion and the arm portion.

15. The toiletry support system of claim 12, further comprising a sheathing that is configured to attach at the toiletry item via an adhesive, and wherein the sheathing comprises the receptacle that removably engages the arm portion of the hook member.

16. The toiletry support system of claim 15, wherein the sheathing is configured to attach at a plastic container that holds at least one of shampoo, conditioner, or liquid soap.

17. The toiletry support system of claim 12, wherein the wall plate comprises a transparent polymer that is configured to permit the shower wall to be visible through the wall plate.

18. A toiletry support system for a shower wall, said toiletry support system comprising:
a wall plate having an outer planar surface and an inner planar surface opposite the outer planar surface configured to engage a shower wall;
a wall attachment structure disposed at the inner planar surface of the wall plate and configured to attach at and support the wall plate at the shower wall;
a toiletry support structure disposed at the outer planar surface at the wall plate; and
an engagement device configured to be disposed at a toiletry item and removably engage the toiletry support structure to suspend the toiletry item at the wall plate.

19. The toiletry support system of claim 18, wherein the wall attachment structure comprises a suction cup that is configured to engage the shower wall and support the combined weight of the wall plate and the toiletry item supported at the toiletry support structure, and wherein the wall attachment structure comprises a hook member having a base portion attached at the wall plate and an arm portion extending away from the base portion configured to removably engage a receptacle disposed at the toiletry item.

20. The toiletry support system of claim 18, wherein the toiletry support structure comprises a first magnetic attachment member disposed at the outer planar surface of the wall plate, and wherein the engagement device comprises a second magnetic attachment member configured to magnetically couple with the first magnetic attachment member.
